(19) United States
(12) Patent Application Publication
(10) Pub. No.: US 2019/0232695 A1
(43) Pub. Date: Aug. 1, 2019

(54) IMAGE FORMING APPARATUS AND CLEANING METHOD

(71) Applicant: Konica Minolta, Inc., Tokyo (JP)

(72) Inventors: Yukimasa AZUMA, Tokyo (JP); Yusuke Nishisaka, Tokyo (JP); Kuniya Matsuura, Aichi (JP); Taiya Munenaka, Tokyo (JP); Midori Shimomura, Tokyo (JP)

(21) Appl. No.: 16/250,028

(22) Filed: Jan. 17, 2019

(30) Foreign Application Priority Data
Jan. 29, 2018 (JP) 2018-012868

(51) Int. Cl. B41J 29/17; B41J 2/005

(52) U.S. Cl. CPC B41J 29/17; B41J 2/0057

(57) ABSTRACT

An image forming apparatus includes an inkjet head, a hardware processor that controls an imager former so that an untransferred image is formed on a transferer at a position between two continuous transferred images, and a first cleaning member and a second cleaning member that remove the untransferred image formed on the transferer from the transferer.

### CROSS REFERENCE TO RELATED APPLICATIONS

The entire disclosure of Japanese Patent Application No. 2018-012868, filed on Jan. 29, 2018, is incorporated herein by reference in its entirety.

### BACKGROUND

### Technological Field

The present invention relates to an image forming apparatus and a cleaning method.

### Description of Related Art

A transfer type inkjet image forming apparatus causes ink to land on the surface of a transfer section and transfers the ink from the transfer section to a recoding medium to form an image on the surface of the recording medium. In such an image forming apparatus, a transfer residual image which is left on the transfer section without being transferred to the recording medium may be generated at a transfer nip which transfers an image based on the ink from the transfer section to the recording medium. Thus, a cleaning section which removes the transfer residual image is provided.

For example, Japanese Patent Application Laid-Open No. 2000-127359 discloses a configuration provided with a second cleaning section which removes an image adhered to a transfer section during a purge operation in addition to a first cleaning section which removes a transfer residual image.

### SUMMARY

A transfer type inkjet image forming apparatus may form a test image on a transfer section between images during continuous sheet feeding in view of performing image density correction or misalignment correction or preventing head lack.

When a cleaning section removes such a test image without transferring the test image to the recording medium taking the productivity of the image forming apparatus into consideration, the amount of ink of the test image is considerably larger than the amount of ink of a transfer residual image. Thus, the test image cannot be entirely removed by the cleaning section, which causes in insufficient wiping in the transfer section or retransfer from the cleaning section to the transfer section and, in turn, causes a problem that affects the image quality in image formation thereafter.

Further, when a cleaning section whose cleaning power is increased to a degree capable of removing the test image is provided, there is a problem in that a transfer residual image in normal image formation slips through a part of the cleaning section due to a small volume (thickness) of the transfer residual image. Further, there is a problem in that the cleaning power of the cleaning section with respect to the transfer section is too large, which causes wear of the transfer section.

In the configuration described in Japanese Patent Application Laid-Open No. 2000-127359, the test image between images is not taken into consideration. Thus, the above problems cannot be solved.

It is an object of the present invention to provide an image forming apparatus and a cleaning method that are capable of reliably removing a transfer residual image in a transfer section and preventing wear of the transfer section while maintaining the productivity.

To achieve at least one of the abovementioned objects, according to an aspect of the present invention, an image forming apparatus reflecting one aspect of the present invention comprises: an image former that includes an inkjet head and forms an image based on ink ejected from the inkjet head;

a transferer that feeds a transferred image formed by the image former toward a transfer nip to transfer the transferred image to a recording medium at the transfer nip;

a first cleaning member and a second cleaning member that remove an image formed on the transferer from the transferer; and

a hardware processor that controls the image former so that an untransferred image is formed on the transferer at a position between two continuous transferred images, wherein

the first cleaning member and the second cleaning member remove the untransferred image formed on the transferer from the transferer.

To achieve at least one of the abovementioned objects, according to an aspect of the present invention, a cleaning method reflecting one aspect of the present invention is a cleaning method of an image forming apparatus, the image forming apparatus including: an image former that includes an inkjet head and forms an image based on ink ejected from the inkjet head; a transferer that feeds a transferred image formed by the image former toward a transfer nip to transfer the transferred image to a recording medium at the transfer nip; and a first cleaning member and a second cleaning member that remove an image formed on the transferer from the transferer, the cleaning method comprising:

controlling the image former so that an untransferred image is formed on the transferer at a position between two continuous transferred images; and

removing the untransferred image formed on the transferer from the transferer by the first cleaning member and the second cleaning member.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically showing the entire configuration of an image forming apparatus according to an embodiment of the present invention;

FIG. 2 is a diagram showing a principal part of a control system of the image forming apparatus according to the present embodiment;

FIG. 3A is an enlarged view of a cleaning section when a first cleaning member is located at a separated position;

FIG. 3B is an enlarged view of the cleaning section when the first cleaning member is located at a contact position; and

FIG. 4 is a flowchart showing an example of the operation when cleaning control in the image forming apparatus is executed.

### DETAILED DESCRIPTION OF EMBODIMENTS

Hereinafter, one or more embodiments of the present invention will be described with reference to the drawings. However, the scope of the invention is not limited to the disclosed embodiments.

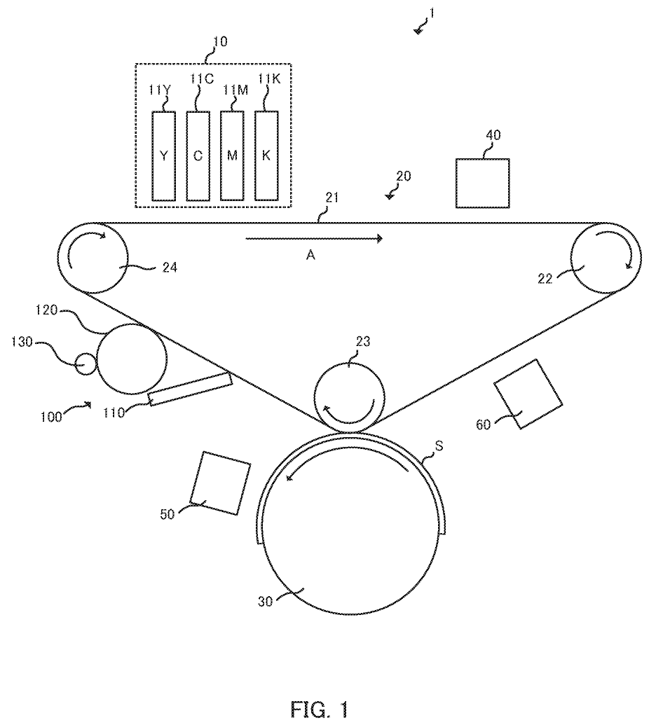

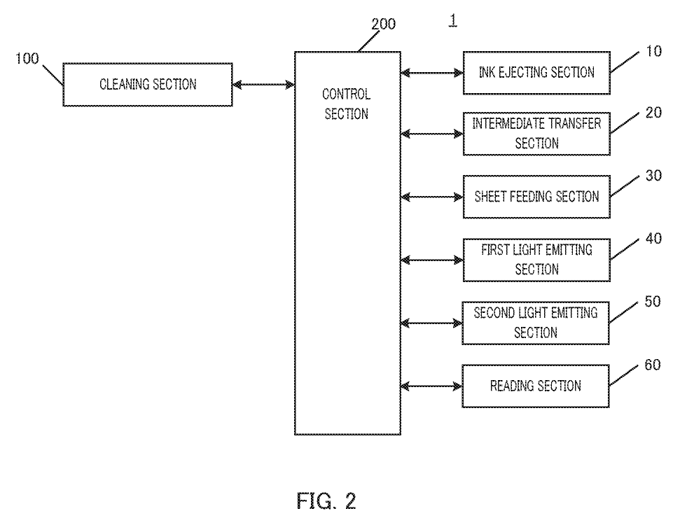

Hereinbelow, an embodiment of the present invention will be described in detail with reference to the drawings. FIG. 1 is a diagram showing the entire configuration of image forming apparatus 1 according to an embodiment of the present invention. FIG. 2 is a diagram showing a principal part of a control system of image forming apparatus 1 according to the present embodiment.

As shown in FIG. 1, image forming apparatus 1 is an intermediate transfer type color image forming apparatus using an inkjet system. Image forming apparatus 1 includes ink ejecting section 10, intermediate transfer section 20, sheet feeding section 30, first light emitting section 40, second light emitting section 50, reading section 60, cleaning section 100, and control section 200 (refer to FIG. 2).

As shown in FIG. 2, control section 200 is provided with a central processing unit (CPU), a read only memory (ROM), and a random access memory (RAM). The CPU reads a program corresponding to processing contents from the ROM and develops the read program in the RAM, and performs centralized control for the operation of each block of image forming apparatus 1 in cooperation with the developed program. At this time, various pieces of data stored in a storage section (not illustrated) are referred to. The storage section (not illustrated) includes, for example, a nonvolatile semiconductor memory (so-called flash memory) or a hard disk drive.

As shown in FIG. 1, ink ejecting section 10 is provided with inkjet heads 11Y, 11C, 11M, and 11K, and ejects ink of the respective colors: Y (yellow); M (magenta); C (cyan); and K (black) to intermediate transfer section 20 to form an image based on the ink. Ink ejecting section 10 corresponds to the “image forming section” of the present invention. Since inkjet heads 11Y, 11C, 11M, and 11K have similar configurations, Y, M, C, and K will be omitted in the following description for convenience.

The ink ejected from each inkjet head 11 may be water ink which contains water and, optionally, a small amount of organic solvent as a liquid component, solvent ink which contains an organic solvent as a liquid component, but contains substantially no water, or actinic radiation-curable ink which contains a photocurable compound which is cured by polymerization and cross-linking by being irradiated with actinic rays such as ultraviolet rays and electron rays as a liquid component. In the present embodiment, the ink ejected from inkjet head 11 is actinic radiation-curable ink.

Intermediate transfer section 20 includes intermediate transfer belt 21 as an example of the transfer section and three support rollers 22, 23, and 24. Intermediate transfer belt 21 is an endless belt and stretched between three support rollers 22, 23, and 24 in an inverted triangular shape. Intermediate transfer belt 21 includes, for example, a surface layer which is made of a material having high chemical resistance such as a fluororesin, a base layer which is made of a resin material such as polyimide, and an elastic layer which is made of silicon rubber. In this manner, intermediate transfer belt 21 has a layer structure of at least two layers including the surface layer made of a material having high chemical resistance and the elastic layer so that intermediate transfer belt 21 has sufficient strength and elasticity while maintaining chemical resistance and wettability.

At least one of three support rollers 22, 23, and 24 is a drive roller and driven under control of control section 200. Accordingly, intermediate transfer belt 21 rotates in an A direction (the clockwise direction in FIG. 1).

A part of intermediate transfer belt 21, the part being stretched between support rollers 22 and 24 which are located at right and left vertexes of the inverted triangular shape, serves as an impact surface of ink ejected from inkjet head 11. Support roller 23 which is located at a lower vertex of the inverted triangular shape in intermediate transfer belt 21 is a pressure roller which presses intermediate transfer belt 21 toward sheet feeding section 30 with a predetermined nip pressure.

Sheet feeding section 30 includes a metallic drum and forms a transfer nip by being pressed by support roller 23. Sheet feeding section 30 includes a claw (not illustrated) which fixes the front end of sheet S. Sheet feeding section 30 fixes the front end of sheet S on the claw under the control of control section 200 and rotates in the counterclockwise direction in FIG. 1 to feed sheet S as an example of the recording medium to the transfer nip.

First light emitting section 40 faces the ink impact surface of intermediate transfer belt 21 on the downstream side of ink ejecting section 10. First light emitting section 40 applies light to an image formed on intermediate transfer belt 21 to pre-cure the image.

Second light emitting section 50 faces a part of sheet feeding section 30, the part being located on the downstream side of the transfer nip, and applies light to an image on sheet S to final-cure the image.

Reading section 60 faces a part of intermediate transfer belt 21, the part being located on the downstream side relative to the impact surface and the upstream side relative to the transfer nip, and reads an image formed on intermediate transfer belt 21.

An image which is formed on the surface of intermediate transfer belt 21 by inkjet head 11 is pre-cured by first light emitting section 40 and fed to the transfer nip between support roller 23 and sheet feeding section 30 by the rotation of intermediate transfer belt 21. Then, the image fed to the transfer nip is transferred to sheet S fed by sheet feeding section 30. The image transferred to sheet S is final-cured by second light emitting section 50.

Further, in view of performing image density correction or misalignment correction between images during continuous sheet feeding, control section 200 controls ink ejecting section 10 so that a test image, which is an untransferred image, is formed on intermediate transfer belt 21 at a position between two continuous transferred images.

The “transferred image” described herein is an image that arrives at the transfer nip at the timing when sheet S is located at the transfer nip, and is transferred to sheet S. Further, the “untransferred image” is an image that arrives at the transfer nip at the timing when sheet S is not located at the transfer nip, and is thus not transferred to sheet S.

When such a test image is transferred to sheet S, the necessity of stopping continuous sheet feeding hallway arises, which deteriorates the productivity. Thus, in the present embodiment, the test image is formed on intermediate transfer belt 21 at the position between two continuous transferred images. Accordingly, the productivity is improved. The test image is removed by cleaning section 100 after passing through the transfer nip.

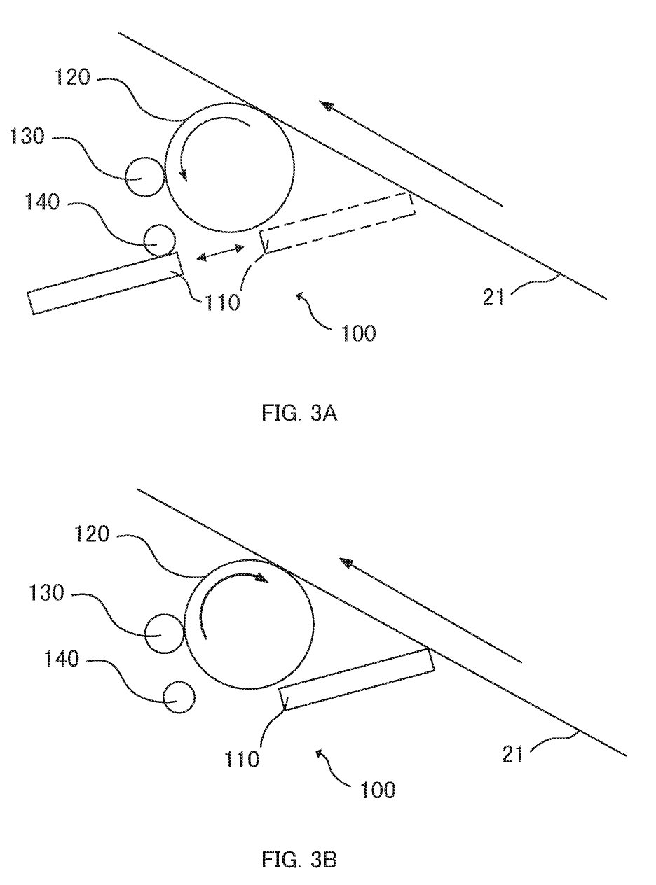

Cleaning section 100 is located on the downstream side relative to the transfer nip, and includes first cleaning member 110, second cleaning member 120, third cleaning member 130, and fourth cleaning member 140 (refer to FIG. 3A).

Cleaning section 100 removes a transfer residual image and the test image which are formed on intermediate transfer belt 21 under the control of control section 200. The “transfer residual image” described herein is a transferred image that is left on intermediate transfer belt 21 without being transferred to sheet S. Cleaning control in cleaning section 100 will be described below.

First cleaning member 110 is a cleaning blade. First cleaning member 110 scrapes away an image formed on intermediate transfer belt 21 by bringing the tip thereof into contact with intermediate transfer belt 21. First cleaning member 110 is capable of coming into contact with and separating from intermediate transfer belt 21.

As shown in FIGS. 1 and 3A, first cleaning member 110 is movable to a contact position (refer to FIG. 1) where first cleaning member 110 is in contact with intermediate transfer belt 21 and a separated position (refer to FIG. 3A) where first cleaning member 110 is separated from intermediate transfer belt 21.

Second cleaning member 120 is a cleaning roller such as a web roller or a sponge roller and in contact with a part of intermediate transfer belt 21 on the downstream side of first cleaning member 110. Second cleaning member 120 is driven to rotate under the control of control section 200 to remove the test image or the transfer residual image.

Third cleaning member 130 is a cleaning roller that is in contact with second cleaning member 120 at the side opposite to intermediate transfer belt 21 with respect to second cleaning member 120. Third cleaning member 130 removes ink that has been removed from intermediate transfer belt 21 by second cleaning member 120 and adhered to second cleaning member 120.

Fourth cleaning member 140 is a cleaning roller that is in contact with first cleaning member 110 located at the separated position. Fourth cleaning member 140 removes ink that has been removed from intermediate transfer belt 21 by first cleaning member 110 and adhered to first cleaning member 110.

Next, the cleaning control in cleaning section 100 will be described.

Control section 200 performs control for changing a cleaning performance with respect to intermediate transfer belt 21 between the transfer residual image which is left on intermediate transfer belt 21 without being transferred to sheet S and the test image which is formed between two continuous transferred images. Control section 200 corresponds to the “cleaning control section” of the present invention.

Specifically, control section 200 performs control for positioning first cleaning member 110 at the separated position in removing the transfer residual image and positioning first cleaning member 110 at the contact position in removing the test image. That is, in removing the test image, intermediate transfer belt 21 is cleaned by first cleaning member 110 and second cleaning member 120 with an improved cleaning performance compared to the cleaning performance in removing the transfer residual image.

In normal image formation, the amount of ink of the test image is considerably larger than the amount of ink of the transfer residual image because the test image is not transferred to sheet S. Thus, the test image cannot be entirely removed by a single cleaning member, which causes insufficient wiping in intermediate transfer belt 21 or retransfer from the cleaning member to intermediate transfer belt 21 and, in turn, causes a problem that affects the image quality in image formation thereafter.

Thus, in the present embodiment, the cleaning performance capable of reliably removing the test image is ensured by using first cleaning member 110 and second cleaning member 120 in removing the test image from intermediate transfer belt 21. As a result, the problem affecting the image quality is less likely to occur.

When the cleaning performance capable of reliably removing the test image is ensured, there is a problem in that the transfer residual image in normal image formation slips through a part of cleaning section 100 due to a smaller volume of the transfer residual image than the volume of the test image which is not transferred to sheet S. Further, there is a problem in that a contact force of first cleaning member 110 against intermediate transfer belt 21 is too large, which causes wear of intermediate transfer belt 21

Thus, in the present embodiment, in removing the transfer residual image from intermediate transfer belt 21, only second cleaning member 120 is used, and first cleaning member 110 is not used. As a result, it is possible to perform appropriate cleaning according to the amount of ink adhered to intermediate transfer belt 21. Thus, the problem of the slipping-through of the transfer residual image and the problem of the wear of intermediate transfer belt 21 are less likely to occur.

As shown in FIGS. 3A and 3B, control section 200 performs control for changing a rotation direction of second cleaning member 120 between the removal of the transfer residual image and the removal of the test image. Specifically, in removing the transfer residual image, control section 200 sets the rotation direction of second cleaning member 120 to the same direction as a feeding direction of intermediate transfer belt 21 in a contact part between second cleaning member 120 and intermediate transfer belt 21 (refer to FIG. 3A).

At this time, a rotation speed of second cleaning member 120 is set to be higher than a feeding speed of intermediate transfer belt 21.

In contrast, in removing the test image, control section 200 sets the rotation direction of second cleaning member 120 to a direction opposite to the feeding direction of intermediate transfer belt 21 in the contact part between second cleaning member 120 and intermediate transfer belt 21 (refer to FIG. 3B).

At this time, an absolute value of the rotation speed of second cleaning member 120 is set to be higher than an absolute value of the rotation speed of second cleaning member 120 in removing the transfer residual image.

Accordingly, in removing the test image, the cleaning performance in a part of second cleaning member 120 can be improved compared to the cleaning performance in removing the transfer residual image. As a result, the cleaning performance in second cleaning member 120 can be adjusted according to the circumstances.

Further, control section 200 determines whether to bring first cleaning member 110 into contact with intermediate transfer belt 21 on the basis of a reading result of reading section 60. Specifically, when reading section 60 has read the test image, control section 200 brings first cleaning member 110 into contact with intermediate transfer belt 21.

Accordingly, first cleaning member 110 can be brought into contact with intermediate transfer belt 21 at the timing when the test image arrives at a part of cleaning section 100. As a result, it is possible to prevent the time of contact between first cleaning member 110 and intermediate transfer belt 21 from becoming long more than necessary.

The time from the timing when a test image is formed on intermediate transfer belt 21 to when the test image arrives at cleaning section 100 may be calculated, and first cleaning member 110 may be brought into contact with intermediate transfer belt 21 at the timing based on the calculated time regardless of the reading result of reading section 60.

Further, control section 200 performs control for at least partially curing the test image by first light emitting section 40 after the test image is formed on the impact surface of intermediate transfer belt 21.

Accordingly, it is possible to increase the viscosity of ink in the test image to make it easy to remove the ink by cleaning section 100.

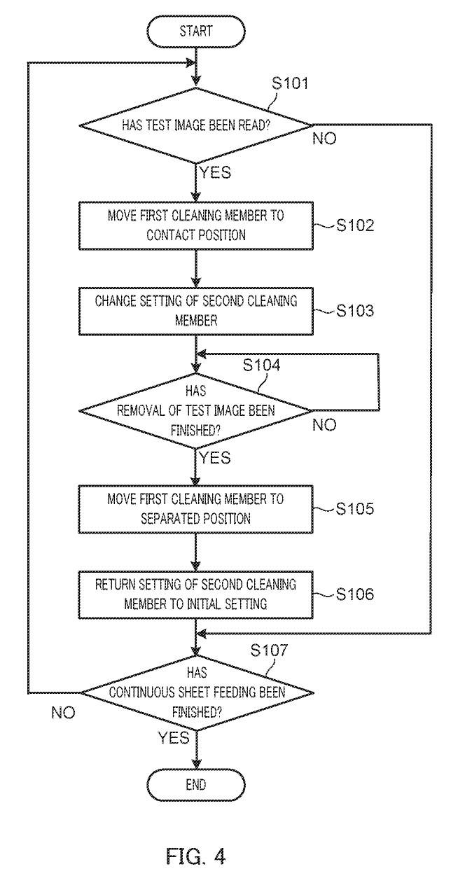

Next, an operation example when the cleaning control in image forming apparatus 1 is executed will be described. FIG. 4 is a flowchart showing an example of the operation when the cleaning control in image forming apparatus 1 is executed. A process in FIG. 4 is executed when control section 200 receives a command for executing continuous sheet feeding.

In cleaning section 100, the position of first cleaning member 110 is set to the separated position and the rotation direction of second cleaning member 120 is set to the same direction as the feeding direction of intermediate transfer belt 21 in the contact part of intermediate transfer belt 21 in initial setting.

As shown in FIG. 4, control section 200 determines whether reading section 60 has read a test image (step S101). When a result of the determination shows that reading section 60 has not read a test image (NO in step S101), the process shifts to step S107.

On the other hand, when reading section 60 has read the test image (YES in step S101), control section 200 moves first cleaning member 110 to the contact position (step S102). Next, control section 200 changers setting of second cleaning member 120 from the initial setting (step S103). Specifically, control section 200 sets the rotation direction of second cleaning member 120 to the direction opposite to the feeding direction of intermediate transfer belt 21 in the contact part of intermediate transfer belt 21 and sets the absolute value of the rotation speed to be higher than the absolute value of the rotation speed in the initial setting.

Next, control section 200 determines whether removal of the test image by cleaning section 100 has been finished (step S104). When a result of the determination shows that the removal of the test image has not been finished (NO in step S104), the process of step S104 is repeated.

On the other hand, when the removal of the test image has been finished (YES in step S104), control section 200 moves first cleaning member 110 to the separated position (step S105). Next, control section 200 returns the setting of second cleaning member 120 to the initial setting (step S106).

Next, control section 200 determines whether the continuous sheet feeding has been finished (step S107). When the continuous sheet feeding has not been finished (NO in step S107), the process returns to step S101. On the other hand, when the continuous sheet feeding has been finished (YES in step S107), the control is finished.

According to the present embodiment configured in the above manner, cleaning section 100 is controlled so that, in removing the test image, the cleaning performance is improved compared to the cleaning performance in removing the transfer residual image. Specifically, first cleaning member 110 and second cleaning member 120 are used in removing the test image, and only second cleaning member 120 is used in removing the transfer residual image.

Accordingly, in removing the test image, it is possible to reliably remove the test image on intermediate transfer belt 21 by first cleaning member 110 and second cleaning member 120. Further, in removing the transfer residual image, first cleaning member 110 is separated from intermediate transfer belt 21. Thus, it is possible to prevent wear of intermediate transfer belt 21 caused by contact of first cleaning member 110 with intermediate transfer belt 21.

Further, since the test image is formed between images in continuous sheet feeding, the productivity of image forming apparatus 1 can be maintained.

Further, first cleaning member 110 is located on the upstream side relative to second cleaning member 120. Thus, a test image that has been removed to some extent by first cleaning member 110 is removed by second cleaning member 120. Thus, a load on second cleaning member 120 can be reduced.

When first cleaning member 110 is located at the separated position, ink adhered to first cleaning member 110 is removed by fourth cleaning member 140. Thus, the cleaning performance by first cleaning member 110 can be maintained.

Further, ink adhered to second cleaning member 120 is removed by third cleaning member 130. Thus, the cleaning performance by second cleaning member 120 can be maintained.

In the above embodiment, the test image adhered to intermediate transfer belt 21 is removed by first cleaning member 110 and second cleaning member 120. However, the present invention is not limited thereto. For example, when an image adhered to intermediate transfer belt 21 is removed by a single cleaning member, the cleaning performance of the cleaning member may be changed. For example, when the cleaning member is a cleaning blade, a contact pressure against intermediate transfer belt 21 may be changed. When the cleaning member is a cleaning roller, a speed ratio or a rotation direction with respect to intermediate transfer belt 21 may be changed.

Although, in the above embodiment, intermediate transfer belt 21 is described as an example of the transfer section, the present invention is not limited thereto. A transfer member other than the intermediate transfer belt may be used.

In addition, the above embodiment merely describes an example of the embodiment for carrying out the present invention, and the technical scope of the present invention should not be limitedly interpreted by the embodiment. That is, the present invention can be carried out in various manners without departing from the gist or the principal characteristic thereof.

Lastly, an evaluation experiment of image forming apparatus 1 according to the present embodiment will be described. First, as a first evaluation experiment, an image corresponding to the test image was formed and passed through cleaning section 100 using image forming apparatus 1 shown in FIG. 1, and a remaining condition of the image on intermediate transfer belt 21 was checked. The ink remaining condition was visually checked.

As a first example, first cleaning member 110 is brought into contact with intermediate transfer belt 21, and the rotation direction of second cleaning member 120 is set to the same direction as the feeding direction of intermediate transfer belt 21. The speed ratio of second cleaning member 120 with respect to intermediate transfer belt 21 is set to 1.5 in the first example.

As a second example, first cleaning member 110 is separated from intermediate transfer belt 21, and the rotation direction of second cleaning member 120 is set to the direction opposite to the feeding direction of intermediate transfer belt 21. The speed ratio of second cleaning member 120 with respect to intermediate transfer belt 21 is set to 2 in the second example.

Further, as a comparative example, first cleaning member 110 is separated from intermediate transfer belt 21, and the setting of second cleaning member 120 is the same as the setting in the first example.

The test image formed on intermediate transfer belt 21 is an image having a magenta color, a liquid amount of 10 pl, a dot ratio of 100%, and a horizontal band of 10%, corresponding to the length of B2 size.

Intermediate transfer belt 21 in the evaluation experiment includes the surface layer which is made of a material having high chemical resistance such as a fluororesin, the base layer which is made of a resin material such as polyimide, and the elastic layer which is made of silicon rubber.

Among support rollers 22, 23, and 24 which support intermediate transfer belt 21, support roller 23 corresponding to the transfer nip has a diameter of 100 mm and includes an elastic layer having a rubber thickness of 10 mm.

First light emitting section 40 is an ultraviolet LED light source having a wavelength of 395 nm and an irradiation intensity of 50 to 1000 mW/cm². Second light emitting section 50 is an ultraviolet LED light source having a wavelength of 395 nm and an irradiation intensity of 5000 mW/cm².

The axial-direction length of intermediate transfer belt 21 and each of the rollers is 800 mm, and a load on sheet feeding section 30 by support roller 23 in the transfer nip is 80 N. The printing speed is 600 mm/s. Further, OK Top Coat (manufactured by Oji Paper Co., Ltd.) having a basis weight of 84.9 g/m² is used as sheet S.

Table 1 shows an evaluation result of the first evaluation experiment. In Table 1, “A” indicates a case where substantially no ink was left on intermediate transfer belt 21 after cleaning, and “B” indicates a case where ink was obviously left on intermediate transfer belt 21 after cleaning.

TABLE 1

| | Evaluation result |
|---|---|
| First example | A |
| Second example | A |
| Comparative example | B |

According to Table 1, it has been confirmed that ink was obviously left on intermediate transfer belt 21 after cleaning in the comparative example. In contrast, in both the first example and the second example, it has been confirmed that substantially no ink was left on intermediate transfer belt 21 after cleaning. That is, the effectiveness of the present embodiment has been confirmed.

Next, as a second evaluation experiment, images for transfer were formed on sheets S after 300 kp continuous sheet feeding using image forming apparatus 1 shown in FIG. 1, and it was checked whether a vertical streak is generated. A test image is formed on intermediate transfer belt 21 between the images during 300 kp continuous sheet feeding.

A first example is performed under the same conditions as the first evaluation experiment for the test image and under a condition where first cleaning member 110 is separated from intermediate transfer belt 21 for the image for transfer.

A second example is performed under the same conditions as the first evaluation experiment for the test image and under conditions where the rotation direction of second cleaning member 120 is set to the same direction as the feeding direction of intermediate transfer belt 21 and the speed ratio of second cleaning member 120 with respect to intermediate transfer belt 21 is set to 1.5 for the image for transfer.

Further, as a comparative example, second cleaning member 120 is not provided, and first cleaning member 110 is continuously brought into contact with intermediate transfer belt 21.

The test image formed on intermediate transfer belt 21 is an image having a magenta color, a liquid amount of 10 pl, a dot ratio of 100%, and a horizontal band of 10%, corresponding to the length of B2 size. The image for transfer formed on intermediate transfer belt 21 is an image having a magenta color, a liquid amount of 3.5 pl, a dot ratio of 50%, and a horizontal band of 20%, corresponding to the length of B2 size.

The other experiment conditions are the same as the conditions in the first evaluation experiment.

Table 2 shows an evaluation result of the second evaluation experiment. In Table 2, “A” indicates a case where no vertical streak was detected in the image for transfer formed on sheet S after 300 kp, and “B” indicates a case where a vertical streak was detected in the image for transfer formed on sheet S after 300 kp.

TABLE 2

| | Evaluation result |
|---|---|
| First example | A |
| Second example | A |
| Comparative example | B |

According to Table 2, it has been confirmed that a vertical streak was detected in the image for transfer formed on sheet S after 300 kp in the comparative example. In contrast, in both the first example and the second example, it has been confirmed that no vertical streak was detected on the image for transfer formed on sheet S after 300 kp. That is, the effectiveness of the present embodiment has been confirmed.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus comprising:
an image former that includes an inkjet head and forms an image based on ink ejected from the inkjet head;
a transferer that feeds a transferred image formed by the image former toward a transfer nip to transfer the transferred image to a recording medium at the transfer nip;
a first cleaning member and a second cleaning member that remove an image formed on the transferer from the transferer; and
a hardware processor that controls the image former so that an untransferred image is formed on the transferer at a position between two continuous transferred images, wherein
the first cleaning member and the second cleaning member remove the untransferred image formed on the transferer from the transferer.

2. An image forming apparatus comprising:
an image former that includes an inkjet head and forms an image based on ink ejected from the inkjet head;
a transferer that feeds a transferred image formed by the image former toward a transfer nip to transfer the transferred image to a recording medium at the transfer nip;
a cleaner that is located on a downstream side relative to the transfer nip in a feeding direction of the transferer and removes a transfer residual image left on the transferer without being transferred to the recording medium from the transferer; and
a hardware processor that controls the image former so that an untransferred image is formed on the transferer at a position between two continuous transferred images, wherein
the hardware processor controls the cleaner so that, in removing the untransferred image on the transferer, a cleaning performance is improved compared to a cleaning performance in removing the transfer residual image on the transferer.

3. The image forming apparatus according to claim 1, wherein
the first cleaning member is located on the downstream side relative to the transfer nip in the feeding direction of the transferer and capable of coming into contact with and separating from the transferer,
the second cleaning member is located on the downstream side relative to the transfer nip in the feeding direction and removes a transfer residual image left on the transferer without being transferred to the recording medium and the untransferred image from the transferer, and
the hardware processor
controls the first cleaning member and the second cleaning member so that, in removing the untransferred image on the transferer, a cleaning performance is improved compared to a cleaning performance in removing the transfer residual image on the transferer,
separates the first cleaning member from the transferer in removing the transfer residual image on the transferer, and
brings the first cleaning member into contact with the transferer in removing the untransferred image on the transferer.

4. The image forming apparatus according to claim 2, wherein
the cleaner includes
a first cleaning member capable of coming into contact with and separating from the transferer, and
a second cleaning member that removes the transfer residual image and the untransferred image on the transferer, and
the hardware processor
separates the first cleaning member from the transferer in removing the transfer residual image on the transferer, and
brings the first cleaning member into contact with the transferer in removing the untransferred image on the transferer.

5. The image forming apparatus according to claim 3, wherein the second cleaning member is located on the downstream side relative to the first cleaning member in the feeding direction.

6. The image forming apparatus according to claim 3, further comprising a light emitter that is disposed on an upstream side relative to the first cleaning member in the feeding direction and applies actinic rays to an image formed on the transferer, wherein
the ink is actinic radiation-curable ink, and
the hardware processor controls the light emitter so that the untransferred image on the transferer is at least partially irradiated with the actinic rays.

7. The image forming apparatus according to claim 3, wherein the first cleaning member is a blade member.

8. The image forming apparatus according to claim 3, wherein
the second cleaning member is a roller member that is rotatable and in contact with the transferer, and
in removing the untransferred image on the transferer, the hardware processor sets an absolute value of a rotation speed of the second cleaning member to be higher than an absolute value of the rotation speed in removing the transfer residual image and rotates the second cleaning member in a direction opposite to the feeding direction in a contact part between the second cleaning member and the transferer.

9. The image forming apparatus according to claim 3, further comprising a third cleaning member that removes ink adhered to the second cleaning member.

10. The image forming apparatus according to claim 3, further comprising a fourth cleaning member that removes ink adhered to the first cleaning member.

11. The image forming apparatus according to claim 3, further comprising a reader that reads the untransferred image, wherein
the hardware processor brings the first cleaning member into contact with the transferer when the reader has read the untransferred image.

12. The image forming apparatus according to claim 3, wherein the transferer has a layer structure of at least two layers.

13. A cleaning method of an image forming apparatus, the image forming apparatus including: an image former that includes an inkjet head and forms an image based on ink ejected from the inkjet head; a transferer that feeds a transferred image formed by the image former toward a transfer nip to transfer the transferred image to a recording medium at the transfer nip; and a first cleaning member and a second cleaning member that remove an image formed on the transferer from the transferer, the cleaning method comprising:
controlling the image former so that an untransferred image is formed on the transferer at a position between two continuous transferred images; and
removing the untransferred image formed on the transferer from the transferer by the first cleaning member and the second cleaning member.

14. A cleaning method of an image forming apparatus, the image forming apparatus including: an image former that includes an inkjet head and forms an image based on ink ejected from the inkjet head; a transferer that feeds a transferred image formed by the image former toward a transfer nip to transfer the transferred image to a recording medium at the transfer nip; and a cleaner that is located on a downstream side relative to the transfer nip in a feeding direction of the transferer and removes a transfer residual image left on the transferer without being transferred to the recording medium from the transferer, the cleaning method comprising:
controlling the image former so that an untransferred image is formed on the transferer at a position between two continuous transferred images; and
controlling the cleaner so that, in removing the untransferred image on the transferer, a cleaning performance is improved compared to a cleaning performance in removing the transfer residual image on the transferer.
